(19) United States
(12) Patent Application Publication
(10) Pub. No.: US 2016/0377717 A1
(43) Pub. Date: Dec. 29, 2016

(54) SYSTEMS AND METHODS FOR ADAPTIVE SAMPLING OF DOPPLER SPECTRUM

(71) Applicant: EDAN INSTRUMENTS, INC., Shenzhen (CN)

(72) Inventors: Seshadri Srinivasan, Sunnyvale, CA (US); Jiang Zhiqiang, Sunnyvale, CA (US)

(73) Assignee: EDAN INSTRUMENTS, INC., Shenzhen, (CN)

(21) Appl. No.: 15/195,476

(22) Filed: Jun. 28, 2016

Related U.S. Application Data
(60) Provisional application No. 62/186,273, filed on Jun. 29, 2015.

(51) Int. Cl. G01S 15/89; G01S 7/52

(52) U.S. Cl. CPC G01S 15/8977; G01S 7/5206; G01S 15/8911

(57) ABSTRACT

An ultrasound imaging system is provided. The ultrasound imaging system includes an ultrasound transducer configured to acquire ultrasound imaging information including an ultrasound data sample. The ultrasound imaging system includes a processing circuit configured to receive the ultrasound imaging information and applying a combining function to the ultrasound imaging information based on a characteristic of the ultrasound imaging information, in order to combine the ultrasound imaging information into at least one spectral Doppler line. The combining function improves an image quality of an image displayed based on the at least one spectral Doppler line.

### CROSS-REFERENCE TO RELATED APPLICATIONS

This application claims the benefit of and priority to U.S. Provisional Application No. 62/186,273, titled “SYSTEMS AND METHODS OF ADAPTIVE SAMPLING OF DOPPLER SPECTRUM,” filed Jun. 29, 2015, which is incorporated herein by reference in its entirety.

### FIELD

The present disclosure relates to ultrasound imaging and, more particularly, to systems and methods for improving ultrasound image quality by reducing sampling of spectra.

### BACKGROUND

Ultrasound imaging is an important and attractive tool for a wide variety of applications (e.g., diagnostic medical imaging, non-diagnostic medical imaging, etc.). Ultrasound devices (e.g., an ultrasound imaging system, an ultrasound probe, a portable ultrasound probe or scanner, etc.) create an image of a patient by producing and emitting ultrasonic waves with a transducer. The ultrasonic waves produce echoes that return towards the transducer. The transducer measures the returning echoes of the waves to provide data regarding the patient. The data may be analyzed and assembled into an image of the patient using a computing device. Ultrasound image quality is affected by a number of factors, including signal-to-noise ratio (SNR), contrast-to-noise ratio (CNR), frequency resolution, and gap artefacts in duplex and triplex mode.

Conventional ultrasound imaging systems compute a single spectrum for every displayed spectral Doppler line. One or more data samples acquired by an ultrasound device may be skipped for every displayed spectral Doppler line. Data samples may be skipped based on a sweep speed (e.g., a speed at which an ultrasound signal beam is swept across a target region), a pulse repetition frequency (PRF) (e.g., a number of pulses of an ultrasound signal in a certain time period), and a sample skip factor “k,” which may be a constant value. Based on such variables, data samples may be skipped such that every “nth” data sample is displayed as a spectral Doppler line. Skipping data samples may allow for real-time displaying of spectral Doppler lines, but may also result in reduced image quality.

### SUMMARY

One embodiment relates to an ultrasound imaging system. The ultrasound imaging system includes an ultrasound transducer and a processing circuit. The ultrasound transducer is configured to acquire ultrasound imaging information including an ultrasound data sample. The processing circuit is configured to receive the ultrasound imaging information, and apply a combining function to the ultrasound imaging information based on a characteristic of the ultrasound imaging information in order to combine the ultrasound imaging information into at least one spectral Doppler line. The combining function improves an image quality of an image displayed based on the at least one spectral Doppler line.

Another embodiment relates to an ultrasound imaging system. The ultrasound imaging system includes a processing circuit and a display interface. The processing circuit is configured to receive a plurality of ultrasound data samples, and compute a spectral Doppler line for each of the plurality of ultrasound data samples. The display interface is configured to operate in a high resolution mode, in which the display interface displays each of the spectral Doppler lines.

Another embodiment relates to a method of adaptive spectral sampling of ultrasound imaging information. The method includes receiving ultrasound imaging information comprising a plurality of ultrasound data samples, computing a plurality of imaging lines based on the ultrasound data samples and an imaging skip, computing a combining function based on a characteristic of the ultrasound imaging information, and combining the imaging lines into a spectral Doppler line based on the combining function.

Another embodiment relates to a method of displaying ultrasound information in high resolution. The method includes receiving a plurality of ultrasound data samples, computing a spectral Doppler line for each of the plurality of ultrasound data samples, and displaying each of the spectral Doppler lines in an image.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 illustrates an embodiment of an ultrasound imaging system incorporating aspects of the invention.

FIG. 2 illustrates a front view of one embodiment of an ultrasound imaging system.

FIG. 3 illustrates a block diagram of components of one embodiment of an ultrasound imaging system.

FIG. 4 illustrates a schematic diagram of one embodiment of ultrasound data samples acquired by an ultrasound imaging system and ultrasound spectral Doppler lines displayed by an ultrasound imaging system.

FIG. 5 illustrates a block diagram of one embodiment of a method of adaptive sampling of Doppler spectra.

FIG. 6 illustrates a block diagram of one embodiment of a method of implementing adaptive sampling of Doppler spectra in a signal processing pathway performed by an ultrasound imaging system.

### DETAILED DESCRIPTION

Before turning to the Figures, which illustrate the exemplary embodiments in detail, it should be understood that the present application is not limited to the details or methodology set forth in the description or illustrated in the Figures. It should also be understood that the terminology is for the purpose of description only and should not be regarded as limiting. For illustrative purposes, ultrasound processing and imaging systems using adaptive sampling of Doppler spectra are shown according to various example embodiments herein.

Referring to the Figures generally, the various embodiments disclosed herein relate to systems and methods for adaptive sampling of Doppler spectra. According to the present disclosure, an ultrasound imaging system is configured to receive ultrasound imaging information (e.g., ultrasound data samples) acquired by an image acquisition device, such as an ultrasound transducer/probe. The ultrasound imaging system is configured to apply a combining function to the ultrasound imagining information based on a characteristic of the imaging information. A sample spectrum, such as an imaging line, may be computed for each ultrasound data sample before being combine in the combining function. The combining function combines the ultrasound imaging information into at least one spectral Doppler line. The at least one spectral Doppler line is displayed by the ultrasound imaging system, such as on a display interface. The combining function improves an image quality of the at least one spectral Doppler line when the at least one spectral Doppler line is displayed as an image on the display interface. For example, the combining function may improve an SNR, a CNR, a frequency resolution, gap artefacts in duplex and triplex modes of operation of the ultrasonic imaging system, etc. The characteristic of the imaging information may include a statistical function of the imaging information, such as a mean, maximum, minimum, and/or standard deviation of a signal component or a noise component of the imaging information. The number of imaging lines computer and the number of spectral Doppler lines displayed per ultrasound data sample acquired may depend on factors such as a sweep speed of the ultrasonic transducer/probe, a PRF, a sample skip factor, an imaging skip factor, etc. In some embodiments, a high-resolution or zoom mode of operation allows for displaying all imaging lines, or for displaying all imaging lines in a region of time or space, such as a region selected by a user.

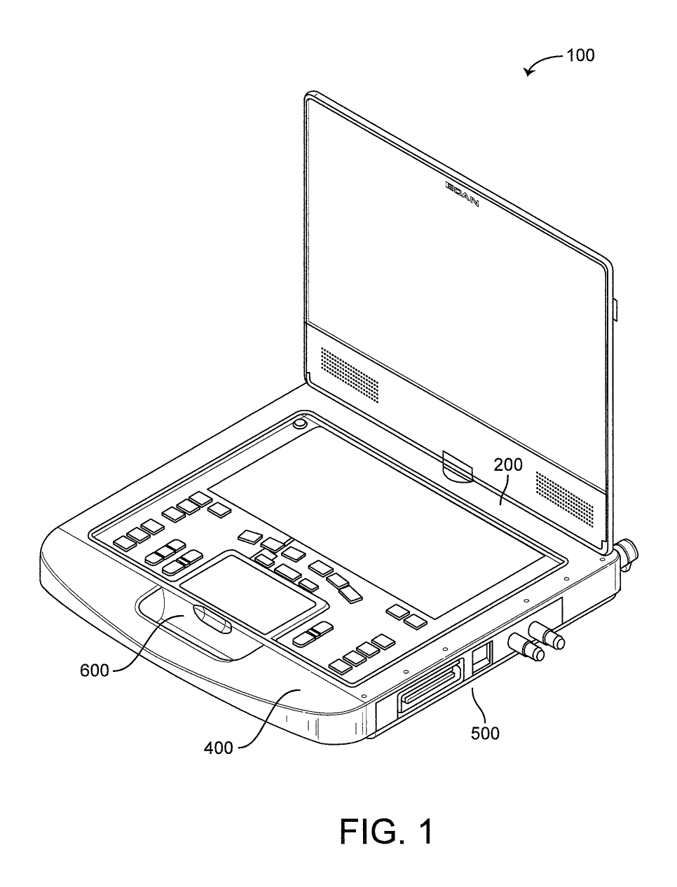

Referring to FIG. 1, one embodiment of portable ultrasound system 100 is illustrated. Portable ultrasound system 100 may include display support system 200 for increasing the durability of the display system. Portable ultrasound system 100 may further include locking lever system 500 for securing ultrasound probes and/or transducers. Some embodiments of portable ultrasound system 100 include ergonomic handle system 400 for increasing portability and usability. Further embodiments include status indicator system 600 which displays, to a user, information relevant to portable ultrasound system 100. Portable ultrasound system 100 may further include features such as an easy to operate and customizable user interface, adjustable feet, a backup battery, modular construction, cooling systems, etc.

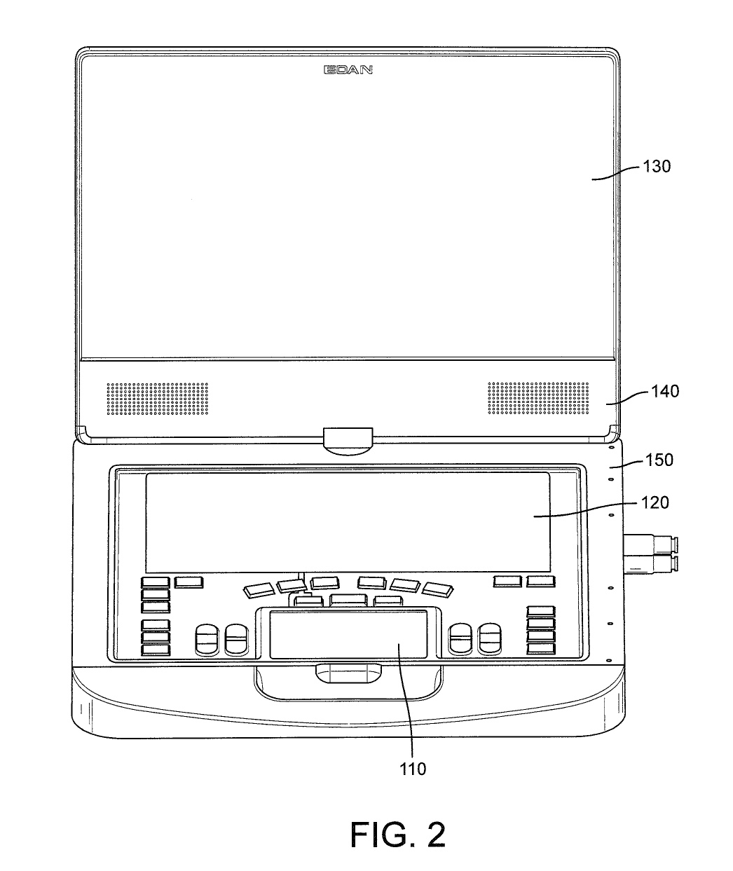

Referring to FIG. 2, a front view of one embodiment of portable ultrasound system 100 is illustrated. Main housing 150 houses components of portable ultrasound system 100. In some embodiments, the components housed within main housing 150 include locking lever system 500, ergonomic handle system 400, and status indicator system 600. Main housing 150 may also be configured to support electronics modules which may be replaced and/or upgraded due to the modular construction of portable ultrasound system 100. In some embodiments, portable ultrasound system 100 includes display housing 140. Display housing 140 may include display support system 200. In some embodiments, portable ultrasound system 100 includes touchpad 110 for receiving user inputs and displaying information, touchscreen 120 for receiving user inputs and displaying information, and main screen 130 for displaying information.

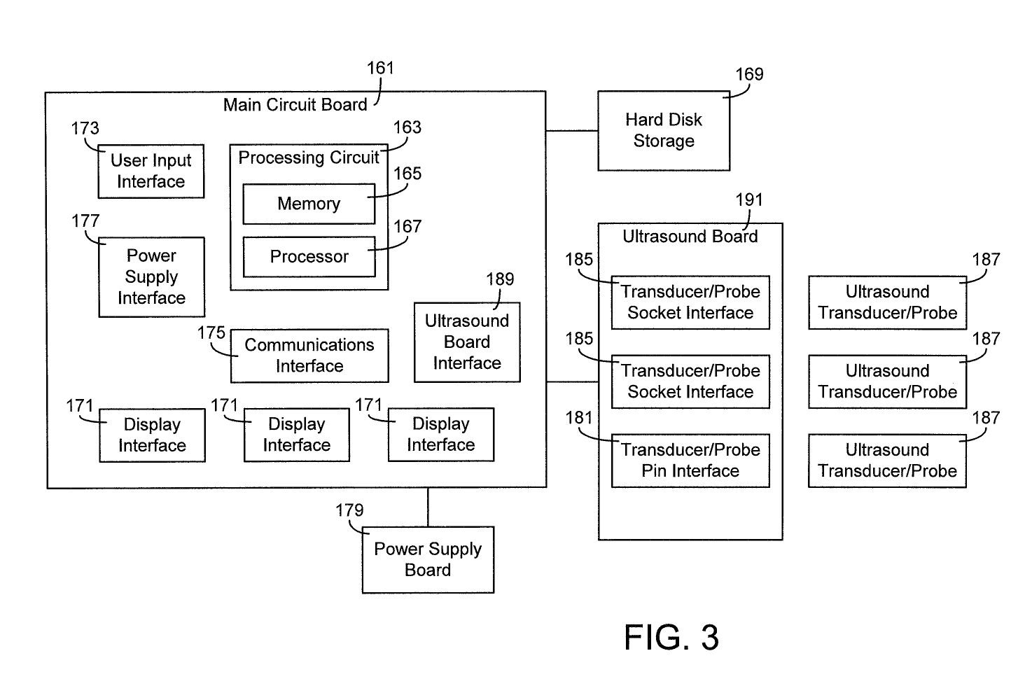

Referring to FIG. 3, a block diagram shows internal components of one embodiment of portable ultrasound system 100. Portable ultrasound system 100 includes main circuit board 161. Main circuit board 161 carries out computing tasks to support the functions of portable ultrasound system 100 and provides connection and communication between various components of portable ultrasound system 100. In some embodiments, main circuit board 161 is configured so as to be a replaceable and/or upgradable module.

To perform computational, control, and/or communication tasks, main circuit board 161 includes processing circuit 163. Processing circuit 163 is configured to perform general processing and to perform processing and computational tasks associated with specific functions of portable ultrasound system 100. For example, processing circuit 163 may perform calculations and/or operations related to producing an image from signals and or data provided by ultrasound equipment, running an operating system for portable ultrasound system 100, receiving user inputs, etc. Processing circuit 163 may include memory 165 and processor 167 for use in processing tasks. For example, processing circuit 163 may perform calculations and/or operations. Processing circuit 163 may perform operations related to ultrasound data sampling, displaying spectral Doppler lines, combining ultrasound data samples and sample spectra to improve SNR and other qualities of the displayed images, producing images in real-time, producing high-resolution images, etc.

Processor 167 may be, or may include, one or more microprocessors, application specific integrated circuits (ASICs), circuits containing one or more processing components, a group of distributed processing components, circuitry for supporting a microprocessor, or other hardware configured for processing. Processor 167 is configured to execute computer code. The computer code may be stored in memory 165 to complete and facilitate the activities described herein with respect to portable ultrasound system 100. In other embodiments, the computer code may be retrieved and provided to processor 167 from hard disk storage 169 or communications interface 175 (e.g., the computer code may be provided from a source external to main circuit board 161).

Memory 165 can be any volatile or non-volatile computer-readable storage medium capable of storing data or computer code relating to the activities described herein. For example, memory 165 may include modules which are computer code modules (e.g., executable code, object code, source code, script code, machine code, etc.) configured for execution by processor 167. Memory 165 may include computer executable code related to functions including ultrasound imagining, battery management, handling user inputs, displaying data, transmitting and receiving data using a wireless communication device, etc. For example, memory 165 may include computer executable code related to ultrasound data sampling and analysis, including adaptive spectral sampling, combining ultrasound data samples, etc. In some embodiments, processing circuit 163 may represent a collection of multiple processing devices (e.g., multiple processors, etc.). In such cases, processor 167 represents the collective processors of the devices and memory 165 represents the collective storage devices of the devices. When executed by processor 167, processing circuit 163 is configured to complete the activities described herein as associated with portable ultrasound system 100. In some embodiments, the systems and methods disclosed herein for adaptive spectral sampling improve the functionality of portable ultrasound system 100, including processing circuit 163, by reducing computational overhead for processing circuit 163, allowing for real-time display of spectral Doppler lines; improving SNR, CNR, and frequency resolution; reducing gap artefacts in duplex and triplex modes of operation of portable ultrasound system 100; etc.

Hard disk storage 169 may be a part of memory 165 and/or used for non-volatile long term storage in portable ultrasound system 100. Hard disk storage 169 may store local files, temporary files, ultrasound images, patient data, an operating system, executable code, and any other data for supporting the activities of portable ultrasound device 100 described herein. In some embodiments, hard disk storage is embedded on main circuit board 161. In other embodiments, hard disk storage 169 is located remote from main circuit board 161 and coupled thereto to allow for the transfer of data, electrical power, and/or control signals. Hard disk 169 may be an optical drive, magnetic drive, a solid state hard drive, flash memory, etc.

In some embodiments, main circuit board 161 includes communications interface 175. Communications interface 175 may include connections which enable communication between components of main circuit board 161 and communications hardware. For example, communications interface 175 may provide a connection between main circuit board 161 and a network device (e.g., a network card, a wireless transmitter/receiver, etc.). In further embodiments, communications interface 175 may include additional circuitry to support the functionality of attached communications hardware or to facilitate the transfer of data between communications hardware and main circuit board 161. In other embodiments, communications interface 175 may be a system on a chip (SOC) or other integrated system which allows for transmission of data and reception of data. In such a case, communications interface 175 may be coupled directly to main circuit board 161 as either a removable package or embedded package.

Some embodiments of portable ultrasound system 100 include power supply board 179. Power supply board 179 includes components and circuitry for delivering power to components and devices within and/or attached to portable ultrasound system 100. In some embodiments, power supply board 179 includes components for alternating current and direct current conversion, for transforming voltage, for delivering a steady power supply, etc. These components may include transformers, capacitors, modulators, etc. to perform the above functions. In further embodiments, power supply board 179 includes circuitry for determining the available power of a battery power source. In other embodiments, power supply board 179 may receive information regarding the available power of a battery power source from circuitry located remote from power supply board 179. For example, this circuitry may be included within a battery. In some embodiments, power supply board 179 includes circuitry for switching between power sources. For example, power supply board 179 may draw power from a backup battery while a main battery is switched. In further embodiments, power supply board 179 includes circuitry to operate as an uninterruptable power supply in conjunction with a backup battery. Power supply board 179 also includes a connection to main circuit board 161. This connection may allow power supply board 179 to send and receive information from main circuit board 161. For example, power supply board 179 may send information to main circuit board 161 allowing for the determination of remaining battery power. The connection to main circuit board 161 may also allow main circuit board 161 to send commands to power supply board 179. For example, main circuit board 161 may send a command to power supply board 179 to switch from source of power to another (e.g., to switch to a backup battery while a main battery is switched). In some embodiments, power supply board 179 is configured to be a module. In such cases, power supply board 179 may be configured so as to be a replaceable and/or upgradable module. In some embodiments, power supply board 179 is or includes a power supply unit. The power supply unit may convert AC power to DC power for use in portable ultrasound system 100. The power supply may perform additional functions such as short circuit protection, overload protection, undervoltage protection, etc. The power supply may conform to ATX specification. In other embodiments, one or more of the above described functions may be carried out by main circuit board 161.

Main circuit board 161 may also include power supply interface 177 which facilitates the above described communication between power supply board 179 and main circuit board 161. Power supply interface 177 may include connections which enable communication between components of main circuit board 161 and power supply board 179. In further embodiments, power supply interface 177 includes additional circuitry to support the functionality of power supply board 179. For example, power supply interface 177 may include circuitry to facilitate the calculation of remaining battery power, manage switching between available power sources, etc. In other embodiments, the above described functions of power supply board 179 may be carried out by power supply interface 177. For example, power supply interface 177 may be a SOC or other integrated system. In such a case, power supply interface 177 may be coupled directly to main circuit board 161 as either a removable package or embedded package.

With continued reference to FIG. 3, some embodiments of main circuit board 161 include user input interface 173. User input interface 173 may include connections which enable communication between components of main circuit board 161 and user input device hardware. For example, user input interface 173 may provide a connection between main circuit board 161 and a capacitive touchscreen, resistive touchscreen, mouse, keyboard, buttons, and/or a controller for the proceeding. In one embodiment, user input interface 173 couples controllers for touchpad 110, touchscreen 120, and main screen 130 to main circuit board 161. In other embodiments, user input interface 173 includes controller circuitry for touchpad 110, touchscreen 120, and main screen 130. In some embodiments, main circuit board 161 includes a plurality of user input interfaces 173. For example, each user input interface 173 may be associated with a single input device (e.g., touchpad 110, touchscreen 120, a keyboard, buttons, etc.).

In further embodiments, user input interface 173 may include additional circuitry to support the functionality of attached user input hardware or to facilitate the transfer of data between user input hardware and main circuit board 161. For example, user input interface 173 may include controller circuitry so as to function as a touchscreen controller. User input interface 173 may also include circuitry for controlling haptic feedback devices associated with user input hardware. In other embodiments, user input interface 173 may be a SOC or other integrated system which allows for receiving user inputs or otherwise controlling user input hardware. In such a case, user input interface 173 may be coupled directly to main circuit board 161 as either a removable package or embedded package. In some embodiments, user interface 173 allows a user to select modes of operation of portable ultrasound system 100 and components thereof, such as selecting a zoom mode, high-resolution mode, and/or real-time mode of operation of display interface 171.

Main circuit board 161 may also include ultrasound board interface 189 which facilitates communication between ultrasound board 179 and main circuit board 161. Ultrasound board interface 189 may include connections which enable communication between components of main circuit board 161 and ultrasound board 191. In further embodiments, ultrasound board interface 189 includes additional circuitry to support the functionality of ultrasound board 191. For example, ultrasound board interface 189 may include circuitry to facilitate the calculation of parameters used in generating an image from ultrasound data provided by ultrasound board 191. In some embodiments, ultrasound board interface 189 is a SOC or other integrated system. In such a case, ultrasound board interface 189 may be coupled directly to main circuit board 161 as either a removable package or embedded package.

In other embodiments, ultrasound board interface 189 includes connections which facilitate use of a modular ultrasound board 191. Ultrasound board 191 may be a module (e.g., ultrasound module) capable of performing functions related to ultrasound imaging (e.g., multiplexing sensor signals from an ultrasound probe/transducer, controlling the frequency of ultrasonic waves produced by an ultrasound probe/transducer, etc.). The connections of ultrasound board interface 189 may facilitate replacement of ultrasound board 191 (e.g., to replace ultrasound board 191 with an upgraded board or a board for a different application). For example, ultrasound board interface 189 may include connections which assist in accurately aligning ultrasound board 191 and/or reducing the likelihood of damage to ultrasound board 191 during removal and or attachment (e.g., by reducing the force required to connect and/or remove the board, by assisting, with a mechanical advantage, the connection and/or removal of the board, etc.).

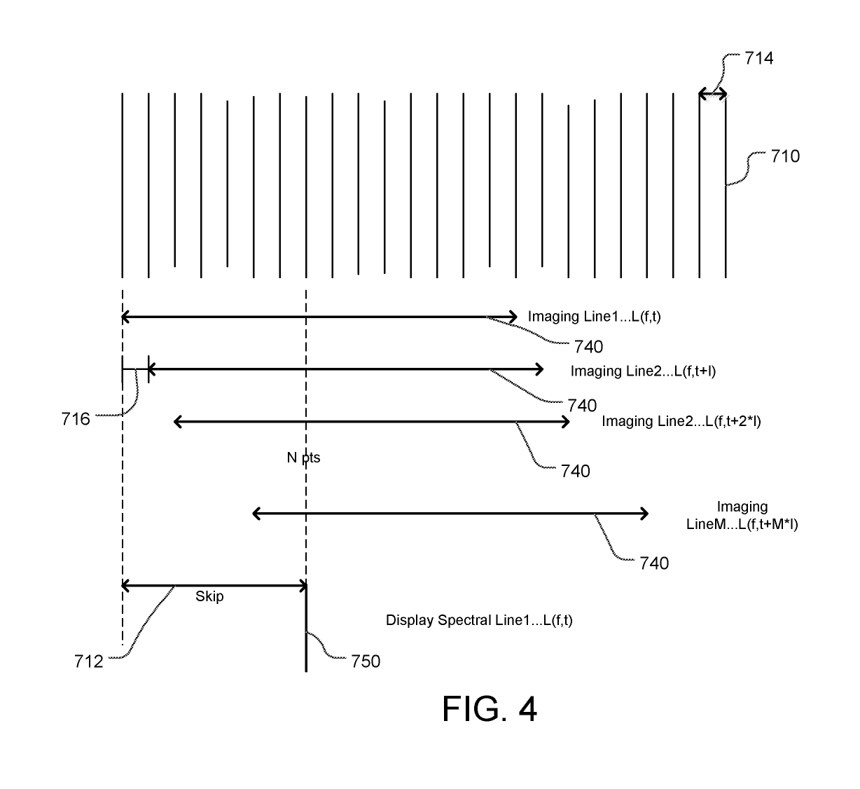

In embodiments of portable ultrasound system 100 including ultrasound board 191, ultrasound board 191 includes components and circuitry for supporting ultrasound imaging functions of portable ultrasound system 100. In some embodiments, ultrasound board 191 includes integrated circuits, processors, and memory. Ultrasound board 191 may also include one or more transducer/probe socket interfaces 185. Transducer/probe socket interface 185 enables ultrasound transducer/probe 187 (e.g., a probe with a socket type connector) to interface with ultrasound board 191. For example, transducer/probe socket interface 185 may include circuitry and/or hardware connecting ultrasound transducer/probe 187 to ultrasound board 191 for the transfer of electrical power and/or data. Transducer/probe socket interface 185 may include hardware which locks ultrasound transducer/probe 187 into place (e.g., a slot which accepts a pin on ultrasound transducer/probe 187 when ultrasound transducer/probe 187 is rotated). In some embodiments, ultrasound board 191 includes two transducer/probe socket interfaces 185 to allow the connection of two socket type ultrasound transducers/probes 187. Ultrasound transducer/probe 187 is configured to acquire ultrasound data, ultrasound imaging information (e.g., ultrasound data samples 710 shown in FIG. 4, etc.), etc.

In some embodiments, ultrasound board 191 also includes one or more transducer/probe pin interfaces 181. Transducer/probe pin interface 181 enables an ultrasound transducer/probe 187 with a pin type connector to interface with ultrasound board 191. Transducer/probe pin interface 181 may include circuitry and/or hardware connecting ultrasound transducer/probe 187 to ultrasound board 191 for the transfer of electrical power and/or data. Transducer/probe pin interface 181 may include hardware which locks ultrasound transducer/probe 187 into place. In some embodiments, ultrasound transducer/probe 187 is locked into place with locking lever system 500. In some embodiments, ultrasound board 191 includes more than one transducer/probe pin interfaces 181 to allow the connection of two or more pin type ultrasound transducers/probes 187. In such cases, portable ultrasound system 100 may include one or more locking lever systems 500. In further embodiments, ultrasound board 191 may include interfaces for additional types of transducer/probe connections.

With continued reference to FIG. 3, some embodiments of main circuit board 161 include display interface 171. Display interface 171 may include connections which enable communication between components of main circuit board 161 and display device hardware. For example, display interface 171 may provide a connection between main circuit board 161 and a liquid crystal display, a plasma display, a cathode ray tube display, a light emitting diode display, and/or a display controller or graphics processing unit for the proceeding or other types of display hardware. In some embodiments, the connection of display hardware to main circuit board 161 by display interface 171 allows a processor or dedicated graphics processing unit on main circuit board 161 to control and/or send data to display hardware. Display interface 171 may be configured to send display data to display device hardware in order to produce an image. For example, display interface 171 may display an image produced from spectral Doppler lines. Display interface 171 may display an image based on data acquired by portable ultrasound system 100 in real-time. In some embodiments, main circuit board 161 includes multiple display interfaces 171 for multiple display devices (e.g., three display interfaces 171 connect three displays to main circuit board 161). In other embodiments, one display interface 171 may connect and/or support multiple displays. In one embodiment, three display interfaces 171 couple touchpad 110, touchscreen 120, and main screen 130 to main circuit board 161.

In further embodiments, display interface 171 may include additional circuitry to support the functionality of attached display hardware or to facilitate the transfer of data between display hardware and main circuit board 161. For example, display interface 171 may include controller circuitry, a graphics processing unit, video display controller, etc. In some embodiments, display interface 171 may be a SOC or other integrated system which allows for displaying images with display hardware or otherwise controlling display hardware. Display interface 171 may be coupled directly to main circuit board 161 as either a removable package or embedded package. Processing circuit 163 in conjunction with one or more display interfaces 171 may display images on one or more of touchpad 110, touchscreen, 120, and main screen 130.

In various embodiments, various ultrasound imaging systems may be provided with some or all of the features of the portable ultrasound system illustrated in FIGS. 1-3. In various embodiments, various ultrasound imaging systems may be provided as a portable ultrasound system, a portable ultrasound transducer, a hand-held ultrasound device, a cart-based ultrasound system, an ultrasound system integrated into other diagnostic systems, etc.

Referring to FIG. 4, an embodiment of ultrasound data samples 710 acquired by an ultrasound imaging system (e.g., an ultrasound imaging system including portable ultrasound system 100 shown in FIG. 1, etc.) used to display spectral Doppler lines 750 is illustrated. Ultrasound data samples 710 occur at pulse repetition frequency (“PRF”) 714. Display skip “S” 712 is used to determine how frequently spectral Doppler lines 750 are displayed. Display skip S 712 may be determined based on factors including a sweep speed (e.g., a sweep speed determined by operational parameters of portable ultrasound system 100, etc.), a skip factor “k” (e.g., a constant between 1 and 16, a constant between 1 and 128, a constant that is equal to PRF, a constant that is an inverse of S, a constant that is a function of a memory capacity or other computational capacity of portable ultrasound system 100, etc.), and PRF 714. In some embodiments, display skip S 712 is determined as:

S=k*sweep speed/PRF Eqn. 1.

Imaging skip “I” 716 is used to determine which ultrasound data sample(s) 710 are converted into imaging lines 740. For example, as shown in FIG. 4, each imaging line 740 is based on a plurality of ultrasound data samples 710, and each imaging line 740 (e.g., imaging line 740 representing a function of the plurality of ultrasound data samples 710) is offset from a previous and/or following imaging line by imaging skip I 716. Imaging skip I 716 may be determined based on factors including the sweep speed, PRF 714, the skip factor k, and an imaging skip factor r, where r is less than k. In some embodiments, imaging skip I 716 is determined as:

I=r*sweep speed/PRF Eqn. 2.

A skip ratio “M” may be determined as the ratio of the display skip S 712 to imaging skip I 716. The skip ratio M may thus represent a ratio of r to k, and thus represent a ratio of how imaging lines are determined in relation to how spectral Doppler lines 750 are displayed. In some embodiments, the skip ratio M is a pre-determined value, such as a pre-determined value stored in computer executable code in memory 165 and/or hard disk storage 169. In some embodiments, a user may control the skip ratio M using a user interface (e.g., user interface 173 shown in FIG. 3). For example, a user may control the skip ratio M in order to tune a displayed image, such as for tuning display of spectral Doppler lines 750, for improving SNR, CNR, and/or other qualities of displayed images.

In some embodiments, imaging lines 740 are determined as a function of a frequency f of ultrasound data samples 710 and a time t. For example, first imaging line 740 may be determined based on the frequencies of a plurality of ultrasound data samples 710 acquired beginning at a time t; second imaging line 740 may be determined based on the frequencies of a plurality of ultrasound data samples 710 acquired beginning at a time t +I; third imaging line 740 may be determined based on the frequencies of a plurality of ultrasound data samples 710 acquired beginning at a time t+2*I; and a plurality M of imaging lines 740 may thus be based on the frequencies of ultrasound data samples 710 from time t through time t+M*I. In various embodiments, various characteristics of ultrasound data samples 710 may be used to determine imaging lines 740 (e.g. magnitude, Fast Fourier Transform (“FFT”), etc.). In some embodiments, each imaging line 740 is based on “N” ultrasound data samples 710. In various embodiments, the number of ultrasound data samples 710 used to determine a particular imaging line 740 may vary, such as variations based on properties of the target to be imaged, etc. As shown in FIG. 4, I is less than N, and thus there is an overlap between ultrasound data samples 710 used to determine at least two consecutive imaging lines 740.

Spectral Doppler line 750 is determined based on imaging lines 740, and displayed after display skip S 712 units (e.g., units of time) following time t, following a previous displayed spectral Doppler line 750. As will be described herein, various methods may be used to determine spectral Doppler line 750, including but not limited to combining imaging lines 740 using characteristics of imaging lines 740, using characteristics of the target to be imaged, and using preferences provided by a user.

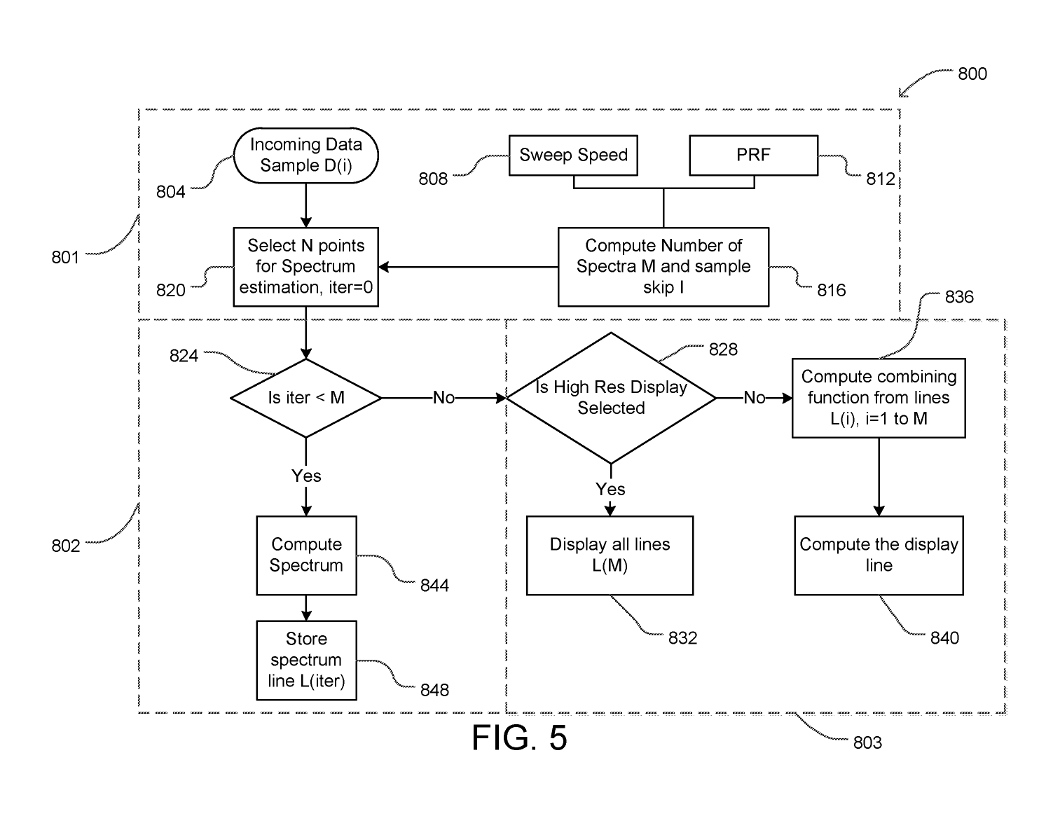

Referring to FIG. 5, a block diagram of method 800 of adaptive sampling of Doppler spectrum is illustrated. Method 800 may be implemented using a variety of ultrasound imaging systems, including portable ultrasound system 100 shown in FIGS. 1-3. For example, some or all of the steps of method 800 may be implemented using components of portable ultrasound system 100 illustrated in FIG. 3, including but not limited to processing circuit 163, display interface 171, and ultrasound transducer/probe 187. In some embodiments, method 800 is implemented in real-time. In some embodiments, method 800 may be contemplated as being performed as a single method 800 including steps 804-848. In some embodiments, method 800 may be contemplated as being performed using sub-process 801 including steps 804-820; sub-process 802 including steps 824, 844, and 848; and sub-process 803 including steps 828-840. In various embodiments, various other sub-processes may be organized using the steps of method 800. In various embodiments, sub-processes 801, 802, and 803 may be performed synchronously (e.g., in which a single data stream passes through method 800 before method 800 may be repeated; in which a single logical flow through the method 800 occurs before method 800 may be repeated; etc.). In various embodiments, sub-processes 801, 802, and 803 may be performed asynchronously (e.g., in which data streams may pass through at least one of sub-processes 801, 802, and/or 803 multiple times before passing to a different sub-process 801, 802 and/or 803; in which various numbers of logical flows may occur in at least one of sub-processes 801, 802, and/or 803 before connecting to a different sub-process 801, 802, and/or 803; etc.). At 801, data samples are received and parameters of the ultrasound analysis system are prepared in order to perform the adaptive sampling; at 802, sample spectra are computed (e.g. by iteratively computing imaging display lines based on data samples); at 803, display lines are computed and displayed.

At 804, an incoming data sample D(i) is received. The incoming data sample D(i) may include at least one data point, such as at least one ultrasound data sample 710 as shown in FIG. 4. The incoming data sample D(i) may include a plurality of data points, such as a plurality of ultrasound data samples 710. The incoming data sample D(i) may be received from portable ultrasound system 100, such as from ultrasound transducer 187 of portable ultrasound system 100 as shown in FIG. 3.

At 808, a sweep speed is determined. The sweep speed may be determined based on an operational parameter or other property of portable ultrasound system 100, user input such as through user input interface 173, an ultrasound analysis computer code stored in memory 165 and/or hard disk storage 169, properties of the target to be imaged, a sweep speed determined by ultrasound transducer/probe 187, etc. In some embodiments, the sweep speed may be modified based on properties of the incoming data sample D(i).

At 812, a PRF is determined. The PRF may be determined based on an operational parameter or other property of portable ultrasound system 100, user input such as through user input interface 173, an ultrasound analysis computer code stored in memory 165 and/or hard disk storage 169, properties of the target to be imaged, a PRF determined based on an operation parameter or other property of ultrasound transducer/probe 187, etc. In some embodiments, the sweep speed may be modified based on properties of the incoming data sample D(i).

At 816, a number of sample spectra M and a sample skip I (e.g., imaging skip I 716 shown in FIG. 4, etc.) are determined based on the sweep speed and the PRF. For example, imaging skip I 716 may be determined using Eqn. 2. Factors k and r as described above may be used for determining the number of sample spectra M and imaging skip I 716. In some embodiments, at least one of factor k, factor r, the number of sample spectra M, and the sample skip I are pre-determined, such as being provided with an ultrasound analysis computer code stored in memory 165 and/or hard disk storage 169. In some embodiments, at least one of factor k, factor r, the number of sample spectra M, and the sample skip I are determined at least partially through user input, such as through user input interface 173. In various embodiments, the number of sample spectra M could vary according to factors including but not limited to a location in a target to be imaged, a location in an image to be displayed, the PRF, and flow features (e.g., maximum velocity, mean velocity, etc.).

At 820, a number N of data samples D(i) are selected for spectrum estimation. If spectrum estimation and computation is to be performed iteratively (e.g., using step 802), an iteration parameter “iter” is initialized to zero. The number of sample spectra M and imaging skip I 716 may be passed through step 820 and may inform the number N of selected data samples D(i). In various embodiments, the number N of data samples D(i) may vary between N and N*M.

At 824, a control step for controlling iterative sub-process 802 is performed by checking the iter against the number of sample spectra M. For example, in some embodiments, multiple imaging lines 740 are calculated based on data samples D(i).

If iter is less than M, then at 844, a sample spectrum (e.g., imaging line 740 shown in FIG. 4, etc.) is computed (e.g., an FFT is performed on a data sample D(i)). At 848, the sample spectrum is stored, such as in memory 165 and/or hard disk storage 169. The sample spectrum may later be retrieved for display and/or combining into a displayed spectral Doppler line 750.

If iter is greater than or equal to M, then computation of sample spectra is complete, and the adaptive spectral sampling and display may continue. At 828, a determination is made as to whether the data should be displayed in “High Resolution Display” mode. For example, a display mode setting may be provided in ultrasound analysis computer code provided in memory 165 and/or hard disk storage 169, and may be set to a High Resolution Display mode. A user may also select High Resolution Display mode, such as by interacting with user input interface 173, by providing an instruction to display sample spectra in High Resolution display mode, etc.

If High Resolution Display mode is selected, then at 832, sample spectra are displayed in High Resolution Display mode. Sample spectra may be displayed on a display interface such as display interface 171. In some embodiments, High Resolution Display mode displays all M sample spectra computed for a given set of data samples D(i). Accordingly, High Resolution Display mode may provide a lossless or otherwise high fidelity representation of an ultrasound image. In some embodiments, High Resolution Display mode displays all sample spectra computed for a region of time and/or a region of space. A user may select the region of time and/or region of space by interacting with user input interface 173.

In some embodiments, a “Zoom” mode is provided, which may be similar to the High Resolution Display mode. For example, a user may interact with user input interface 173 and/or display interface 171 to select a region of the displayed ultrasound image to be zoomed in on, and multiple sample spectra may be displayed in the selected zoomed in region.

If High Resolution Display mode is not selected, then at 836, a combining function is computed. The combining function allows for adaptive sampling of sample spectra in order to improve SNR, CNR, frequency resolution, and gap-artefacts in duplex and triplex mode. At 840, one or more sample spectra are combined to produce a display line (e.g., displayed spectral Doppler line 750 shown in FIG. 4).

The combining function computed at 836 may be computed based on various characteristics or qualities of the data samples D(i), portable ultrasound system 100, ultrasound transducer/probe 187, ultrasound analysis software stored in memory 165 and/or hard disk storage 169, user input provided through user input interface 173, remote input provided through communications interface 175, etc. In some embodiments, the combining function combines the sample spectra by averaging the sample spectra. In some embodiments, improvement of the output from portable ultrasound system 100, such as improving SNR, is achieved by selecting a maximum function for the signal, and a minimum function for the noise. In some embodiments, image quality is maintained or increased while computational load on processing circuit 163 is decreased by adaptive spectral sampling using a combining function.

In some embodiments, the combining function is computed using characteristics of the data samples D(i). For example, the combining function may be computed using statistics of the data samples D(i) and/or sample spectra, such as a maximum, a minimum, a mean, a standard deviation, etc. In some embodiments, the statistics may be based on either nominal values or values grouped by signal vs. noise. In some embodiments, a characteristic may include a statistical function of a signal component of the data samples D(i), and a noise component of the data samples D(i). For example, Eqns. 3-4 illustrate an embodiment of a combining function configured to improve the SNR of spectral Doppler lines 750 to be displayed:

$$\begin{matrix} Out ( f , t ) = a * Max ( f , t ) + ( 1 - a ) * Mean ( f , t ) ; \\ t ∈ \{ 1 , 2 , … M \} , & Eqn . 3 \\ a = \{ \begin{matrix}0 , & Mean ( f , t ) - NoiseMean < Th 1 \\ {a}_{ma x} * \frac{Mean ( r , l ) - Th 1}{Th 2 - Th 1} , & \begin{matrix}Th 1 \leq Mean ( f , t ) - \\ NoiseMean < Th 2\end{matrix} \\ {a}_{m ax} , & Mean ( f , t ) - NoiseMean \geq Th 2\end{matrix} , & Eqn . 4\end{matrix}$$

where Th1 and Th2 represent threshold values. In some embodiments, the combining function adaptively samples spectra by weighing spectra based on spectra characteristics. In some embodiments, the threshold values are provided with computer executable ultrasound analysis code stored in memory 165 and/or hard disk storage 169 shown in FIG. 3. In some embodiments, the threshold values are determined dynamically, such as by providing feedback regarding image quality to processing circuit 163 in order to update the threshold values based on image quality.

In some embodiments, such as when a bin of data samples D(i) has a low SNR, the combining function may be computed using an average of FFTs applied to data samples D(i) in order to provide spectral Doppler lines 750; in some embodiments, such as when a bin of data samples D(i) has a high SNR, the combining function may be computed using the maximum of the FFTs applied to data samples D(i).

In some embodiments, the combining function is varied as a function of space. For example, the combining function may depend on the depth of a pulse width gate in an image.

In some embodiments, the combining function is varied as a function of flow features, such as maximum velocity or mean velocity. For example, the combining function could scale the significance of certain sample spectra based on whether the mean velocity associated with corresponding data samples D(i) increases or decreases; a relationship (e.g., a ratio) of the mean velocity to the maximum velocity; a relationship of a local velocity to a regional mean or maximum velocity over a region of space or time; etc.

In some embodiments, the combining function is computed using two-dimensional frequency-time methods based on spectral characteristics such as mean velocity or maximum velocity.

In some embodiments, the combining function is computed using image processing methods treating the multiple spectra Doppler lines 750 and sample spectra like a two-dimensional image (e.g., the multiple spectral Doppler lines 750 and/or sample spectra are represented in a two-dimensional space).

In some embodiments, the combining function is computed using image transform functions that are applied to characteristics of the sample spectra and/or data samples D(i). For example, wavelet transform functions could be used to focus on or isolate certain features of the data manipulated by the combining function. Fuzzy logic could be used to treat a signal component and a noise component of the sample spectra and/or data samples D(i) as fuzzy regions.

In some embodiments, the combining function is dynamically calculated. For example, qualities of the data samples D(i) may be tracked over time, and used to inform the combining function. For example, qualities such as NoiseMean shown in Eqn. 4 (e.g., a mean value of the noise component of the data samples D(i)) may be compiled over a recent number of data samples D(i) (e.g., the 10 most recent samples, the 40 most recent samples, a number of recent samples related to display skip S 712 or imaging skip I 716, etc.).

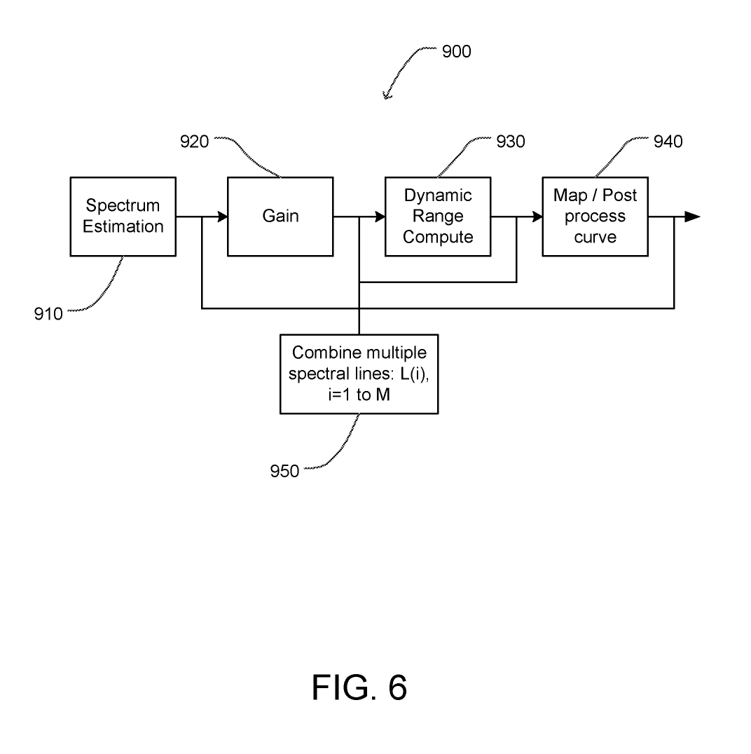

Referring now to FIG. 6, a block diagram of an embodiment of a signal processing pathway 900 is illustrated. Signal processing pathway 900 may be implemented using portable ultrasound system 100 shown in FIGS. 1-3 and or various components therein, including processing circuit 163, user input interface 173, and hard disk storage 169.

At 910, spectrum estimation takes place. Step 910 may be similar or identical to step 844 shown in FIG. 5. For example, sample spectra (e.g., imaging line 740 shown in FIG. 4, etc.) may be estimated based on data samples (e.g., ultrasound data samples 710 shown in FIG. 4, etc.). At 920, gain is applied to the sample spectra. At 930, dynamic range computation/processing occurs. At 940, mapping or other post-processing of sample spectra, such as a curve based on the sample spectra, occurs.

At 950, combination of multiple sample spectra to provide a displayed spectral Doppler line (e.g., spectral Doppler line 750 shown in FIG. 4, etc.) occurs. Step 950 may be similar or identical to steps 836 and/or 840 shown in FIG. 5. For example, a combining function based on Eqn. 3 may be used to combine multiple sample spectra into spectral Doppler line(s) 750. As shown in FIG. 6, step 950 may occur at various points along the signal processing pathway. For example, step 950 may occur after spectrum estimate 910 at 911; before gain 920 at 919; after gain 920 at 921; before dynamic range computation 930 at 929; after dynamic range computation 930 at 931; before mapping/post processing 940 at 939; and/or after mapping/post-processing at 941.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed:

1. An ultrasound imaging system, comprising:
an ultrasound transducer configured to acquire ultrasound imaging information including an ultrasound data sample; and
a processing circuit configured to:
receive the ultrasound imaging information; and
apply a combining function to the ultrasound imaging information based on a characteristic of the ultrasound imaging information in order to combine the ultrasound imaging information into at least one spectral Doppler line;
wherein the combining function improves an image quality of an image displayed based on the at least one spectral Doppler line.

2. The ultrasound imaging system of claim 1, wherein the characteristic includes a statistical function of the ultrasound imaging information.

3. The ultrasound imaging system of claim 2, wherein the statistical function includes at least one of a maximum, a minimum, and a mean of a signal component of the ultrasound imaging information.

4. The ultrasound imaging system of claim 2, wherein the statistical function includes at least one of a maximum, a minimum, and a mean of a noise component of the ultrasound imaging information.

5. The ultrasound imaging system of claim 1, wherein the combining function is varied as a function of space.

6. The ultrasound imaging system of claim 5, wherein the combining function depends on a depth of a pulse width gate in an image.

7. The ultrasound imaging system of claim 1, wherein the characteristic includes a flow feature of a target being imaged.

8. The ultrasound imaging system of claim 7, wherein the flow feature includes at least one of a maximum velocity and a mean velocity.

9. The ultrasound imaging system of claim 1, wherein the processing circuit is configured to determine the combining function using a two-dimensional frequency-time method based on the characteristic.

10. The ultrasound imaging system of claim 1, wherein the processing circuit is configured to determine the combining function using an image transform function.

11. The ultrasound imaging system of claim 1, further comprising a display interface configured to receive the spectral Doppler line and display the spectral Doppler line.

12. An ultrasound imaging system, comprising:
a processing circuit configured to:
receive a plurality of ultrasound data samples; and
compute a spectral Doppler line for each of the plurality of ultrasound data samples; and
a display interface configured to operate in a high resolution mode, in which the display interface displays each of the spectral Doppler lines.

13. The ultrasound imaging system of claim 12, further comprising a user input interface, wherein the user input interface is configured to allow a user to select the high resolution mode.

14. The ultrasound imaging system of claim 12, wherein the user input interface is configured to allow a user to select a region of an image displayed by the display interface to be displayed in the high resolution mode.

15. A method of adaptive spectral sampling of ultrasound imaging information, comprising:
receiving ultrasound imaging information comprising a plurality of ultrasound data samples;
computing a plurality of imaging lines based on the ultrasound data samples and an imaging skip;
computing a combining function based on a characteristic of the ultrasound imaging information; and
combining the imaging lines into a spectral Doppler line based on the combining function.

16. The method of claim 15, wherein the imaging skip depends on a pulse repetition frequency.

17. The method of claim 15, wherein the characteristic includes a statistical function of the ultrasound imaging information.

18. The method of claim 17, wherein the statistical function includes at least one of a maximum, a minimum, and a mean of a signal component of the ultrasound imaging information.

19. The method of claim 17, wherein the statistical function includes at least one of a maximum, a minimum, and a mean of a noise component of the ultrasound imaging information.

20. The method of claim 15, further comprising varying the combining function as a function of space.

21. The method of claim 20, wherein the combining function depends on a depth of a pulse width gate in an image.

22. The method of claim 15, wherein the characteristic includes a flow feature of a target being imaged.

23. The method of claim 22, wherein the flow feature includes at least one of a maximum velocity and a mean velocity.

24. The method of claim 15, wherein the combining function is computed based on an image transform function.

25. The method of claim 15, further comprising receiving an instruction indicating a display mode, and displaying the spectral Doppler line in response to the instruction.

26. The method of claim 15, further comprising displaying the spectral Doppler line as a two-dimensional image based on the combining function including a two-dimensional representation of the imaging lines.

27. A method of displaying ultrasound information in high resolution, comprising:
receiving a plurality of ultrasound data samples;
computing a spectral Doppler line for each of the plurality of ultrasound data samples; and
displaying each of the spectral Doppler lines in an image.

28. The method of claim 27, further comprising selecting a region of the image and selectively displaying the spectral Doppler lines in the image.

29. The method of claim 27, further comprising receiving an instruction to display each of the spectral Doppler lines, and displaying each of the spectral Doppler lines based on the instruction.
